(19) United States
(12) Patent Application Publication
(10) Pub. No.: US 2020/0047468 A1
(43) Pub. Date: Feb. 13, 2020

(54) MULTI-LAYER FILMS BASED ON POLYVINYL ACETAL WITH HIGH PLASTICIZER CONTENT

(71) Applicant: KURARAY EUROPE GMBH, Hattersheim (DE)

(72) Inventors: Uwe KELLER, Avon (FR); Jan BEEKHUIZEN, Troisdorf (DE); Philipp LELLIG, Troisdorf (DE); Michael HAERTH, Troisdorf (DE)

(73) Assignee: KURARAY EUROPE GMBH, Hattersheim (DE)

(21) Appl. No.: 16/340,789

(22) PCT Filed: Oct. 1, 2017
(86) PCT No.: PCT/EP2017/074924

§ 371 Date: Apr. 10, 2019

(30) Foreign Application Priority Data
Oct. 11, 2016 (EP) 16193398.1

(51) Int. Cl. B32B 17/10

(52) U.S. Cl. CPC B32B 17/10761; B32B 17/10605; B32B 2250/04; B32B 2250/40; B32B 2605/08; B32B 2307/412; B32B 2307/56; B32B 2307/732; B32B 2419/00; B32B 2307/102

(57) ABSTRACT

An interlayer film for laminated glazing has at least one first and at least one second layer, each layer containing plasticized polyvinyl acetal, the first layer comprising polyvinyl acetal having a polyvinyl alcohol content from 10 to 16% by weight and a plasticizer content of at least 33% by weight, wherein the interlayer film has a total plasticiser content of at least 29% by weight and, when laminated between two glass panes of 2.1 mm thickness, exhibits after at least 4 weeks aging after lamination, a second mode frequency f2 according to ISO PAS 16940 of less than 720 Hz.

### CROSS REFERENCE TO RELATED APPLICATIONS

This application is the U.S. National Phase of PCT Appln. No. PCT/EP2017/074924 filed Oct. 1, 2017, which claims priority 10 to European Application No. 16193398.1 filed Oct. 11, 2016, the disclosures of which are incorporated in their entirety by reference herein.

### BACKGROUND OF THE INVENTION

### 1. Field of the Invention

The invention relates to a plasticiser-containing film based on polyvinyl acetal, provided with least two layers of which at least one layer has a high plasticiser content for use in laminated glazing.

### 2. Description of the Related Art

It is well known that vibration and sound transmission behaviour of laminated safety glass composed of two plies of glass and a polymeric interlayer depends mostly on glass thickness, interlayer thickness and the coupling and damping effectiveness of the latter at a given temperature.

Conventional films from plasticized polyvinylbutyral (PVB) used as polymeric interlayers exhibit relatively strong coupling but low damping at 20° C. and reduced coupling and increased damping at 40° C., thus rendering a laminated safety glass with a good sound barrier at-this relatively high temperature.

So called “acoustic PVB” using modified plasticized polyvinylbutyral (PVB) offers reduced coupling and increased damping at lower temperature, i.e. around 20° C. Since laminated glass will be exposed mostly to such temperatures, a better sound barrier will be experienced.

In practice, such modification is achieved by increased amounts of plasticizer, which lowers the glass transition temperature (Tg) of the PVB interlayer by about 15-25° C. compared to the conventional plasticized PVB film products.

The increased amount of plasticizer can be present in the entire interlayer, which may cause problems of sticking, elongation during handling and lay-up operations, and weakened mechanical properties in the laminate, unless the overall Tg is not too low.

The increased amount of plasticizer and low Tg may be restricted to a core layer, which is embedded between outer layers of conventional PVB. In this case sticking, handling and interlayer toughness are governed by the outer layers having the desired “conventional” properties. This so-called acoustic tri-layer PVB is nowadays in widespread use for building applications and even more for automotive windscreens.

Mainly driven by weight reduction efforts, windshield laminate construction changed in the past decade from two glass plies each having 2.1 mm thickness combined with a conventional PVB interlayer to laminates comprising glass plies with 2.1 mm and 1.6 mm thickness combined with acoustic tri-layer PVB. Such asymmetric set-up provides lighter and thinner laminates with even better acoustic comfort than the heavier versions.

It is a current target of research and development to further reduce glass thickness and glass weight, without compromising required safety properties. For example, the modification of an acoustic tri-layer to impart stronger coupling to thin glass plies is disclosed in WO 2013/175 101A1. It appears that at the same time as coupling properties are increased, damping properties are slightly reduced. Such modification is achieved by reducing the total plasticizer content in an acoustic tri-layer PVB.

### SUMMARY OF THE INVENTION

Surprisingly it has been found, that to the contrary, enhancing the total plasticizer content in an acoustic multi-layer PVB leads to significant improvement of the sound barrier properties in laminates if the plasticized polyvinylbutyral for the core and outer layers are properly selected. An object of the invention was therefore an interlayer film for laminated glazing, comprising at least one first and at least one second layer, each containing plasticized polyvinyl acetal, wherein the first layer comprises polyvinyl acetal having a polyvinyl alcohol content from 10 to 16% by weight, a plasticizer content of at least 33% by weight and wherein the interlayer film has a total plasticiser content of at least 29% by weight and, when laminated between two glass plies of 2.1 mm thickness, exhibits after 4 weeks aging after lamination, a second mode frequency f2 according to ISO PAS 16940 of less than 720 Hz.

### DETAILED DESCRIPTION OF THE PREFERRED EMBODIMENTS

A surprising feature of the interlayer according to the invention is a significantly improved damping performance at reduced temperature such as 5° C. This is a relevant additional advantage over normal acoustic tri-layer PVB since acoustic performance of a glazing is often measured and rated at 20° C. but naturally is desired to be good at lower and higher temperature as well. This is particularly true for automotive glazing without the constancy of controlled air temperature as is more typical for buildings.

In order to quantify the coupling and damping properties of the new interlayer according to the invention, the impedance test according ISO PAS 16940 is used on laminate beams of 25×300 mm with two plies of 2.1 mm soda lime glass. To reach equilibrium, the impedance test according ISO PAS 16940 is performed on such test laminates after 4 weeks aging after lamination.

In such a layout, interlayers of the invention have a loss factor LF1 at 5° C. of more than >0.10, more than 0.13, more than 0.16 or more than 0.20. LF1 is measured after the test laminate with the interlayer was stored to equilibrate for 2 weeks at 20° C., and then cooled down and measured at 5° C.

The loss factor (LF) is directly related to damping whereas resonance frequency (f) is related to the bending stiffness of the laminated beam which in turn depends on the strength of coupling provided by the interlayer. Due to redistribution of plasticizer between the different layers of multi-layer PVB after a “heat shock” such as the typical autoclave step of safety glass lamination, evaluation of impedance properties was performed after either 2 weeks or 4 weeks of equilibrating the laminates at precisely 20° C. in an humidity controlled (25-30% RH) environment where necessary. A typical autoclave step has for example a 90 min total process duration, with a 30 min heating phase with pressurization up to 12 bar, 30 min hold time at 12 bar and 140° C., 30 min cooling down phase to 40° C. with concomitant release of pressure.

In a first embodiment, interlayer films according to the invention have, in the described test laminates, a resonance frequency f1 as defined in ISO PAS 16940 after equilibration at 20° C. for 4 weeks of less than 160 Hz; less than 150 Hz; less than 140 Hz or less than 130 Hz when measured at 20° C. Preferably, resonance frequencies f1 are in a range of 100-140 Hz and most preferably in a range of 110-130 Hz.

In a second embodiment, interlayer films according to the invention have, in the described test laminates a loss factor LF1 as defined in ISO PAS 16940 after equilibration at 20° C. for 4 weeks of more than 0.20; more than 0.22; more than 0.24; more than 0.26; more than 0.28 or more than 0.30 when measured at 20° C.

In a third embodiment, interlayer films according to the invention have, in the described test laminates, a resonance frequency f2 as defined in ISO PAS 16940 after equilibration at 20° C. for 4 weeks of less than 720 Hz; less than 680 Hz or less than 640 Hz when measured at 20° C. Preferably, resonance frequencies f2 are in a range of 550-680 Hz and most preferably in a range of 600-660 Hz.

In a forth embodiment, interlayer films according to the invention have, in the described test laminates, a loss factor LF2 as defined in ISO PAS 16940 after equilibration at 20° C. for 4 weeks of more than 0.20; more than 0.22; more than 0.24; more than 0.26; more than 0.28 or more than 0.30 when measured at 20° C.

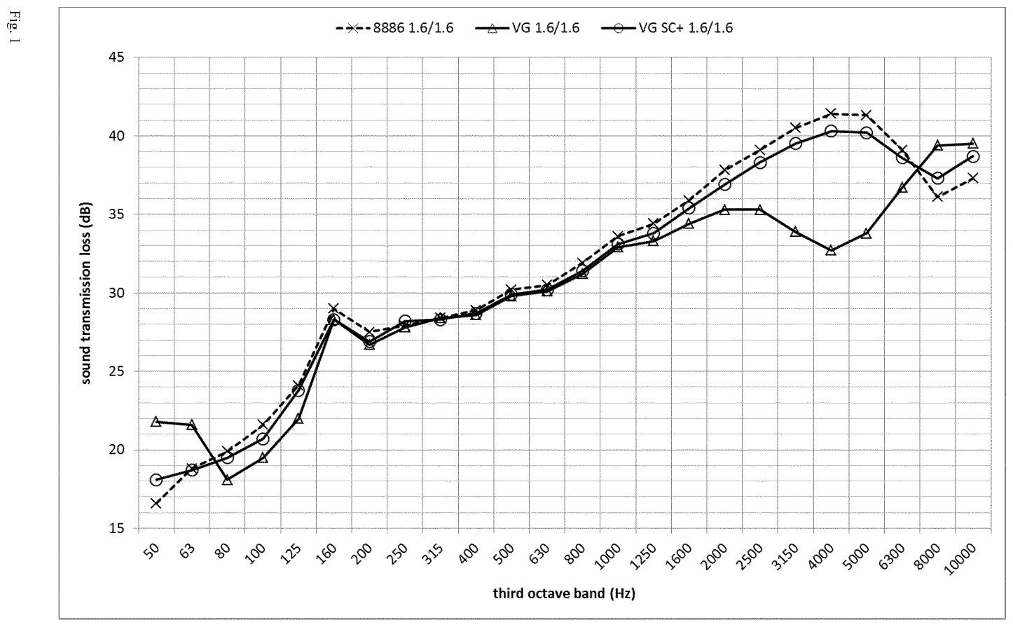

Surprisingly, combining the features of high plasticizer mono-layer PVB in the outer layers with an even more highly plasticized core layer leads to enhanced acoustic barrier properties of the laminated glass in direct acoustic testing according ISO 140 as illustrated in FIG. 1 in direct comparison with normal acoustic tri-layers. This is even more surprising in view of the fact, that the interlayers of the invention do not necessarily exhibit a higher loss factor when compared to normal acoustic tri-layers.

In FIG. 1, the term “8861” refers to an interlayer according to example 2, “VG-SC+” to an acoustic tri-layer film from Kuraray Europe GmbH and “VG” to an acoustic mono-layer film from Kuraray Europe. The term “1.6/1.6” refers the thickness of the glass sheets.

A further surprising and beneficial effect of the invention is the reduction of time to equilibrium after producing the laminate of the invention involving a high temperature step such as autoclaving. While the acoustic stiffness properties—as indicated by the second mode frequency f2—of laminates with normal acoustic tri-layer will continue to change considerably even after 2 weeks of stabilization time at 20° C. due to slow processes of plasticizer diffusion until approaching the equilibrium distribution in the different layers, the new interlayer according to the invention approach such equilibrium faster. It means that f2 value can be initially high (just for purposes of example, 1000 Hz), drops to a lower value after some days (e.g. 900 Hz) and eventually stabilizes around some minimum value (e.g. 800 Hz). Long stabilization times (time elapsed until reaching the minimum value) are encountered with normal acoustic tri-layers, such as 4 weeks or more, whereas this stabilization process is significantly faster for the plasticizer richer interlayer of the present invention. This becomes evident when comparing f2 after 2 weeks with f2 after 4 weeks for laminated beams containing the interlayer of the invention with a conventional acoustic tri-layer. Accordingly, when laminated between 2×2.1 mm glass, f2 after 4 weeks of stabilization time at 20° C. (f2w4) deviates not more than 5%, preferably not more than 4%, more preferably not more than 3%, and most preferably not more than 2% from f2 after 2 weeks of stabilization time at 20° C. (f2w2) for the interlayer of the invention when calculated with the formula below, whereas f2w4 of the laminated beam containing a conventional acoustic tri-layer is found to deviate more than 5% from f2w2.

In a fifth embodiment, interlayer films according to the invention have, in the described test laminate, a ratio of decay of second mode resonance f2 as compared after 2 and 4 weeks of stabilization time at 20° C., based on the staring value f2w2 as defined by formula (f2w2−f2w4)/f2w2×100, of less than 5%, preferably less than 4%, more preferably less than 3%, and most preferably less than 2%.

In a preferred embodiment, the first layer is embedded as a core layer between two identical or different second layers. This embodiment can even be extended to 5 layers with a sequence second/third/first/third/second layers or second/first/third/first/second layers.

The total plasticiser content of the interlayer film is understood hereinafter as the content of plasticiser in relation to the total weight of the film.

Interlayer films according to the invention have a preferred total plasticiser content of more than 29%, more than 29.5% more than 30%, more than 30.5% more than 31%, more than 32%, more than 33%, more than 34%, and even more than 35% by weight. Since a plasticizer content of more than 40% by weight will usually lead to plasticizer exudation, a preferred range of total plasticiser content is between 31-36% by weight and a more preferred range is 32-34%.

The first layer of the interlayer film may have a plasticiser content of more than 33%, more than 35%, more than 37%, more than 39% or more than 40% by weight, with an upper limit of about 65% by weight, since sufficient damping properties are not maintained at too high dilutions of polymer.

The second layer of the interlayer film may have a plasticiser content of more than 28%, more than 29%, more than 30%, more than 32%, more than 33%, or more than 34% by weight with an upper limit of about 40% by weight since mechanical properties and handling of film with higher plasticizer content rapidly degrade.

The interlayer according to the invention can be further described by the glass transition temperatures Tg (as determined with DSC) of the first layer and the second layer. While outer layers of conventional acoustic tri-layer have Tg values close to standard PVB film, i.e. in a range of 17-23° C., the Tg of the second layer is lowered to values of less than 17° C., preferably less than 16° C., more preferably less than 15° C. and especially less than 14° C. for the interlayer of the invention. The Tg of the first layer may be lower than 5° C., 0° C. or preferably lower than −5° C.

Since second outer and first inner layer and optionally additional layers can be present in several thicknesses (d in mm) in the interlayer of the invention, a thickness weighted average Tg is defined as follows:

Thickness weighted average Tg=[d_{(first layer)}×Tg_{(first layer)}+d_{(second layer)}×Tg_{(second layer)}+ . . . +d_{(nth layer)}×Tg_{(nth layer)}]/total film thickness. Total film thickness equals the sum of the thicknesses of all individual layers d_{(first layer)}+d_{(second layer)}+ . . . +d_{(nth layer)}.

In another embodiment of the invention, the interlayer exhibits a thickness weighted average Tg of less than 12° C., less than 10° C., and preferably less than 8° C.

The interlayer film according to the invention may preferably have one or more first layers comprising polyvinyl acetal with a polyvinyl alcohol content of 10-16% by weight 12-15% by weight, and most preferably of 13-14% by weight. The first layer may comprise polyvinyl acetal with different contents of polyvinyl acetate groups, for example a) 0-5 wt % preferably 0 30-3 wt %, or b) 5-8 wt % or c) 8-30 wt %.

The interlayer film according to the invention preferably has two or more second layers comprising polyvinyl acetal with a polyvinyl alcohol content of 14-24% by weight, 16-22% by weight, and most preferably of 17-20% by weight. The second layer may comprise polyvinyl acetal with contents of polyvinyl acetate groups in a range of 0-5 wt % and preferably 0-3 wt %

The layers may have different contents of polyvinyl alcohol groups to achieve different Tg and plasticizer content. Preferably, the difference in content by weight of polyvinyl alcohol groups between the layer having the highest Tg (usually the second layer) and the layer having the lowest Tg (usually the first layer) is less than 10%; less than 8%; less than 7%; less than 6% or less than 5%, and preferably in the range of 4-7%.

The total thickness of the interlayer film may be between 0.3-3 mm or 0.35-2 mm or 0.45-1.8 mm or 0.75-1.35 mm, 0.85-1.2 mm, or most preferably 0.9-1.15 mm.

The thickness of the layer with lowest Tg is preferred between 0.03-0.4 times the total thickness of film, more preferably between 0.075-0.3 times the total thickness of film, and most preferably between 0.1-0.25 times the total thickness of film.

The compatibility of plasticiser and polyvinyl acetal generally decreases with the decrease of the polar nature of the plasticiser. Plasticisers of higher polarity are thus more compatible with polyvinyl acetal than plasticisers of lower polarity. Alternatively, the compatibility of plasticisers of low polarity increases with an increase of the degree of acetalisation, i.e. with decrease of the number of hydroxyl groups and therefore the polarity of the polyvinyl acetal.

Due to the different content of polyvinyl acetal groups, the layers of the interlayer film can accommodate different quantities of plasticisers, without resulting in bleeding out of the plasticiser.

Interlayer films according to the invention can be produced by combining individually extruded layers or preferably by co-extrusion of the layers. The layers may contain identical or different plasticisers in an identical or different quantity prior to the combination with one another. The use of identical plasticisers is preferred, wherein the composition of plasticiser mixtures in the layers may change slightly on account of migration.

The layers of the interlayer films may contain plasticisers or plasticiser mixtures formed from at least one of the following plasticisers known for PVB film: di-2-ethylhexyl sebacate (DOS), di-2-ethylhexyl adipate (DOA), dihexyl adipate (DHA), dibutyl sebacate (DBS), triethylene glycol bis-n-heptanoate (3G7), tetraethylene glycol bis-n-heptanoate (4G7), triethylene glycol bis-2-ethylhexanoate (3GO or 3G8), tetraethylene glycol bis-n-2-ethylhexanoate (4GO or 4G8), di-2-butoxy-ethyl adipate (DBEA), di-2-butoxy-ethoxy-ethyl adipate (DBEEA), di-2-butoxy-ethyl sebacate (DBES), di-2-ethylhexyl phthalate (DOP), di-isononyl phthalate (DINP), triethylene glycol bis-isononanoate, triethylene glycol bis-2-propylhexanoate, 1,2-cyclohexane dicarboxylic acid diisononyl ester (DINCH), tris(2-ethylhexyl) phosphate (TOF) and dipropylene glycol benzoate.

In a preferred embodiment, the first and/or the second layer comprise a mixture of a plasticizer of low polarity, preferably triethylene glycol bis-2-ethylhexanoate (3G8), and at least one additional plasticizer, preferably 1-20%, by weight of at least one plasticizer according to formula I or II

R¹—O(—R²—O)ₙ—CO—R⁵ I

R¹—O(—R²—O)ₙ—CO—R¹—CO—(O—R⁴—)ₘO—R⁶ II
wherein R¹,R⁵,R⁶ are the same or different, and are H or an aliphatic or aromatic residue with 1 to 12 carbon atoms,
R³ is a C—C bond, or an aliphatic or aromatic residue with 1 to 12 carbon atoms
R², R⁴ are the same or different, and are H or an aliphatic or aromatic residue with 1 to 12 carbon atoms,
n and m are the same or different, and are integers from 1 to 10, preferably 1 to 5

Suitable are for example di-(2-butoxyethyl)-adipate (DBEA), Di-(2-butoxyethyl)-sebacate (DBES), Di-(2-butoxyethyl)-azelate, Di-(2-butoxyethyl)-glutarate, Di-(2-butoxyethoxyethyl)-adipate (DBEEA), Di-(2-butoxyethoxyethyl)-sebacate (DBEES), Di-(2-butoxyethoxyethyl)-azelate, Di-(2-butoxyethoxyethyl)-glutarate, Di-(2-hexoxyethyl)-adipate, Di-(2-hexoxyethyl)-sebacate, Di-(2-hexoxyethyl)-azelate, Di-(2-hexoxyethyl)-glutarate, Di-(2-hexoxyethoxyethyl)-adipate, Di-(2-hexoxyethoxyethyl)-sebacate, Di-(2-hexoxyethoxyethyl)-azelate, Di-(2-hexoxyethoxyethyl)-glutarate, Di-(2-butoxyethyl)-phthalate and/or Di-(2-butoxyethoxyethyl)-phthalate.

In addition, the interlayer film according to the invention may contain further additives known to those skilled in the art, such as residual quantities of water, UV absorbers, antioxidants, adhesion regulators, optical brighteners, stabilisers, dyes, processing aids, organic or inorganic nanoparticles, pyrogenic silicic acid and/or surface-active substances.

In a variant of the invention, all layers have the specified additives in largely identical concentration. In a preferred variant of the invention at least one of the layers does not comprise any anti-adhesion agent. Anti-adhesion agents are known to those skilled in the art; in practice, alkaline or alkaline earth metal salts of organic acids, such as potassium/magnesium acetate, are often used for this purpose.

It is also possible for a least one of the layers to contain 0.001 to 20% by weight of SiO₂, preferably 1 to 15% by weight, in particular 5 to 10% by weight, optionally doped with Al₂O₃ or ZrO₂, in order to improve rigidity.

In another embodiment of the invention, the first and/or the second layer comprises a mixture of a plasticizer, preferably one of the previously mentioned plasticizer, more preferably 3G8 or 1,2-cyclohexane dicarboxylic acid diisononyl ester (DINCH), and at least one non-ionic surfactant, optionally with one or more of the additives as already disclosed.

The non-ionic surfactant is preferred an ethoxylated aliphatic or aromatic alcohol, containing at least 6 carbon atoms in the alcohol portion, with an average degree of ethoxylation greater than or equal to 2. Particular preference is given to ethoxylated aliphatic or aromatic alcohols containing from 8 to 20 carbon atoms in the alcohol portion, with an average degree of ethoxylation of from 3 to 10.

Suitable non-ionic surfactants for the purposes of the invention are for example MARLOPHEN® NP 6, a nonylphenol whose average degree of ethoxylation is 6, MARLIPAL® 0 13/40, a fatty alcohol whose average degree of ethoxylation is 4, and ISOFOL 12+5 EO, a 2-butyloctanol whose average degree of ethoxylation is 5. Another example is Berol® 840, a narrowly distributed tetraethoxylated C8 alcohol from Akzo Nobel. Moreover, Ethylan 1003, Ethylan 1005 of Akzo Nobel (both ethoxylated C10 Guerbet alcohols carrying respectively about 3 and 5 EO units), Berol 260 or Berol 266 (ethoxylated C9-11 alcohols with about 4 and 5.5 EO units, respectively). In general, narrow distributed ethoxylates are preferred but standard ethoxylates such as BASF's Lutensol XP range of products are suitable as well (e.g. Lutensol XP 30, XP 40, XP 50, XP 60).

The amount of the non-ionic surfactant(s) which is preferably used from 1 to 25% by weight, more preferably from 5 to 20% by weight and most preferably 8-15% by weight, based on the total film composition. Non-ionic surfactants act as a plasticizer, at the same time enhancing the compatibility of the standard plasticizer and lowering the Tg of the layer(s) concerned. The sum of all plasticizer and non-ionic surfactants present in the film is considered total plasticizer content. Such mixtures present in the sublayers of the interlayer are thus considered “plasticizer”.

In order to produce polyvinyl acetal, polyvinyl alcohol is dissolved in water and is acetalised with an aldehyde, such as butyraldehyde, with addition of an acid catalyst. The precipitated polyvinyl acetal is separated off, washed neutral, optionally suspended in an alkaline aqueous medium, then washed neutral again and dried.

The polyvinyl alcohol content of the polyvinyl acetal can be adjusted by the quantity of the aldehyde used during acetalisation. It is also possible to perform the acetalisation with other or a number of aldehydes having 2-10 carbon atoms (for example valeraldehyde).

The films based on plasticiser-containing polyvinyl acetal preferably contain uncrosslinked polyvinyl butyral (PVB), which is obtained by acetalisation of polyvinyl alcohol with butyraldehyde.

The use of crosslinked polyvinyl acetals, in particular crosslinked polyvinyl butyral (PVB), is also possible. Suitable crosslinked polyvinyl acetals are described for example in EP 1527107 B1 and WO 2004/063231 A1 (thermal self-crosslinking of polyvinyl acetals containing carboxyl groups), EP 1606325 A1 (polyvinyl acetals crosslinked with polyaldehydes) and WO 03/020776 A1 (polyvinyl acetals crosslinked with glyoxylic acid). The disclosure of these patent applications is incorporated herein fully by reference.

In order to produce the films according to the invention, the layers can first be produced individually by extrusion and then combined mechanically, for example by being rolled jointly onto a film reel in order to form the intermediate layer film according to the invention.

It is also possible to produce the interlayer film by simultaneous co-extrusion of the layers. The co-extrusion can be performed for example with an appropriately equipped flat film die or a feed-block.

The interlayer films or single layers according to the invention are generally produced by extrusion or co-extrusion, under conditions (melt pressure, melt temperature and die temperature) so as to obtain a melt fracture surface, i.e. a stochastic surface roughness.

Alternatively, an interlayer film already produced in accordance with the invention can be embossed with a non-stochastic, regular roughness by means of an embossing process between at least one pair of rolls. Embossed films generally have improved deaeration behaviour during the laminated glass production and are used preferably in the automotive field.

Films according to the invention have, independently of the production method, a surface structure applied on one side or particularly preferably on both sides, this surface structure having a roughness R_{z} from 15 to 150 μm, preferably from 15 to 100 μm, most preferably from 20 to 80 μm, and in particular from 30 to 75 μm.

The films according to the invention can be used to produce laminates comprising at least two glass sheets with at least one interlayer film according to the invention wherein the glass sheets have the same or a different thickness.

The laminates according to the invention can be used as automobile and/or architectural window, for example as a windscreen or in windows or transparent façade components, or in furniture making.

For application of the interlayer in an automotive glazing unit, the glass panes may have same or different thickness, for example with an asymmetry of the panes of >10%; >20%; >30%; >50% wherein asymmetry is defined as [A mm−B mm/A mm+B mm]×100 (A, B:glass panes). One or more panes can be chemically hardened. Preferable, so called light weight laminates have a total glass thickness (i.e. sum of glass panes without interlayer) of less than 4.6 mm; less than 3.6 mm; less than 3.3 mm or even less than 3.0 mm. In such laminates, the glass sheets may have a degree of asymmetry of >10%; >20%; >30%; >50% (% asymmetry defined as [A mm−B mm/A mm+B mm]×100).

The general production of interlayer films based on polyvinyl acetals and laminated glass is known to those skilled in the art or is described for example in EP 185 863 B1, EP 1 118 258 B1, WO 02/102591 A1, EP 1 118 258 B1 or EP 387 148 B1.

### Measurement Methods

The polyvinyl alcohol content and polyvinyl acetate content of PVB were determined in accordance with ASTM D 1396-92. The degree of acetalisation (=acetal/butyral content) can be calculated as the remaining portion from the sum of polyvinyl alcohol content and polyvinyl acetate content determined in accordance with ASTM D 1396-92 needed to make one hundred. Conversion from % by weight into mol % is achieved by formulas known to those skilled in the art.

The glass transition temperature of the different layers comprising partly acetalised polyvinyl alcohol and plasticizer was determined by means of differential scanning calorimetry (DSC) in accordance with DIN 53765 with use of a heating rate of 10K/min at a temperature interval of minus 50° C. to 150° C. A first heating ramp, followed by a cooling ramp, followed by a second heating ramp was used. The position of the glass transition temperature was established on the measurement curve associated with the second heating ramp in accordance with DIN 51007. The DIN midpoint (Tg DIN) was defined as the point of intersection of a horizontal line at half step height with the measurement curve. The step height was defined by the vertical distance of the two points of intersection of the middle tangent with the base lines of the measurement curve before and after glass transition.

### Measurement of the Damping Behaviour

In order to quantify the coupling and damping properties of the new interlayer according to the invention, the impedance test according ISO PAS 16940 is used on laminate beams of 25×300 mm with two panes of 2.1 mm soda lime glass. Due to redistribution of plasticizer between the different layers of multi-layer PVB after a “heat shock” such as the typical autoclave step of safety glass lamination, evaluation of impedance properties was performed after either 2 weeks or 4 weeks of equilibration of the laminates at precisely 20° C.

### EXAMPLES

Interlayer films were produced by co-extrusion with the composition as shown in table 1. Hereby the core layer was centered in the middle of the film. Test laminates were produced with conventional 2.1 mm automotive grade soda lime glass (Planiclear®). After the given storage times, the acoustic properties were measured as disclosed according to ISO PAS 16940 with the results shown in table 2. In order to prove that the interlayer films according to the invention are suitable for production of laminated glass, safety tests were performed and shown in table 3.

Table 1 with Comparative Example 1: VG-SC+ acoustic tri-layer film from Kuraray Europe GmbH, Ex 1-5
according to the invention

| | Unit | Comp 1 | Ex1 | Ex2 | Ex3 | Ex3 | Ex4 | Ex5 |
|---|---|---|---|---|---|---|---|---|
| internal reference | | VG-SC+ | K 8885 | K 8886 | K 8887 | K 9084 | K 9085 | K 9086 |
| | | R5 | | | | | | |
| EVERSORB 73 | wt % | 0.15 | 0.15 | 0.15 | 0.15 | 0.15 | 0.15 | 0.15 |
| SONGNOX 2450 PW | wt % | 0.0365 | 0.0365 | 0.0365 | 0.0365 | 0.0365 | 0.0365 | 0.0365 |
| deionized water for | wt % | 0.3 | 0.3 | 0.3 | 0.3 | — | — | — |
| dosing of Mg-salt | | | | | | | | |
| Mg-acetate | wt % | 0.0350 | 0.0375 | 0.0375 | 0.0375 | — | — | — |
| tetrahydrate | | | | | | | | |
| % PVB in extruded | wt % | 72.5 | 66 | 65 | 64 | 64 | 64 | 64 |
| melt outer layer | | | | | | | | |
| PVOH content of PVB | wt % (based | 20.3 | 20.2 | 20.2 | 20.2 | 19.2 | 19.2 | 19.2 |
| outer layer | on PVB) | | | | | | | |
| PVAc content of PVB | wt % (based | 1.1 | 0.7 | 0.7 | 0.7 | 1 | 1 | 1 |
| outer layer, | on PVB) | | | | | | | |
| % plasticizer in | wt % | 27.5 | 34 | 35 | 36 | 36 | 36 | 36 |
| melt outer layer | | | | | | | | |
| % PVB in extruded | wt % | 65 | 65 | 65 | 65 | 64 | 64 | 64 |
| melt core layer | | | | | | | | |
| PVOH content of PVB | wt % (based | 12.2 | 13.5 | 13.5 | 13.5 | 12.2 | 12.2 | 12.2 |
| core layer | on PVB) | | | | | | | |
| PVAc content of PVB | wt % (based | 8.3 | 0.5 | 0.5 | 0.5 | 8.3 | 8.3 | 8.3 |
| core layer | on PVB) | | | | | | | |
| % plasticizer in | wt % | 35 | 35 | 35 | 35 | 36 | 36 | 36 |
| melt inner layer | | | | | | | | |
| Plasticizer | — | 3G8/DBEA | 3G8/ET | 3G8/ET | 3G8/ET | 3G8/ET | 3G8/ET | 3G8/ET |
| composition | | 10:1 | 1003 = 3:1 | 1003 = 3:1 | 1003 = 3:1 | 1003 = 3:1 | 1003 = 3:1 | 1003 = 3:1 |
| total plasticizer | wt % | 29.0 | 33.6 | 34.4 | 35.1 | 35.4 | 35.6 | 34.7 |
| content in film | | | | | | | | |
| Tg DIN outer layer | ° C. | 18.9 | n/a | 10.2 | n/a | n/a | n/a | 3.7 |
| Tg DIN core layer | ° C. | — | n/a | — | n/a | n/a | n/a | — |
| | | −16.8 | | −21.0 | | | | −15.5 |

Table 2 with Comparative Example1: VG-SC+ acoustic tri-layer film from Kuraray Europe
GmbH, Ex 1-5 according to the invention

| | | | | | | | |
|---|---|---|---|---|---|---|---|
| Unit | Comp 1 | Ex1 | Ex2 | Ex3 | Ex3 | Ex4 | Ex5 |

| | | | | | | | |
|---|---|---|---|---|---|---|---|
| internal reference | VG-SC+ | K 8885 | K 8886 | K 8887 | K 9084 | K 9085 | K 9086 |
| | | R5 | | | | | |

samples for impedence test:

| | | | | | | | | |
|---|---|---|---|---|---|---|---|---|
| weight of 25 × 300 mm | g | 86.38 | n/a | n/a | n/a | 86.62 | 89 | 87.9 |
| laminated beam | | | | | | | | |

impedance test ISO PAS 16940 conducted 2 weeks after producing/autoclaving the laminate.
Storage and test temperature 20° C.

| | | | | | | | | |
|---|---|---|---|---|---|---|---|---|
| LF1 @ 20° C. | — | 0.31 | 0.33 | 0.3 | 0.27 | 0.25 | 0.25 | 0.28 |
| LF2 @ 20° C. | — | 0.37 | 0.34 | 0,29 | 0.26 | 0.23 | 0.24 | 0.23 |
| f1 @ 20° C. | Hz | 149 | 138 | 131 | 127 | 122 | 123 | 112 |
| f2 @ 20° C. | Hz | 739 | 670 | 637 | 618 | 600 | 604 | 573 |

impedance test ISO PAS 16940 conducted 4 weeks after producing/autoclaving the laminate.
Storage and test temperature 20° C.

| | | | | | | | | |
|---|---|---|---|---|---|---|---|---|
| LF1 @ 20° C. | — | 0.30 | 0.32 | 0.29 | 0.26 | 0.24 | 0.25 | 0.26 |
| LF2 @ 20° C. | — | 0.36 | 0.32 | 0.29 | 0.26 | 0.22 | 0.23 | 0.22 |
| f1 @ 20° C. | Hz | 145 | 135 | 131 | 126 | 121 | 122 | 111 |
| f2 @ 20° C. | Hz | 702 | 655 | 628 | 610 | 597 | 598 | 567 |

Decay of resoncance frequency:

| | | | | | | | | |
|---|---|---|---|---|---|---|---|---|
| f2w2 − f2w4/(f2w2 + | % | 5.14 | 2.26 | 1.42 | 1.30 | 0.5 | 1.00 | 1.05 |
| f2w4)/2) × 100% | | | | | | | | |
| (f2w2 − | % | 5.01 | 2.24 | 1.41 | 1.29 | 0.50 | 0.99 | 1.05 |
| f2w4)/f2w2 × 100% | | | | | | | | |

impedance test @ 5° C. (after 2 weeks of sample storage at 20° C. after
producing/autoclaving the laminate)

| | | | | | | | | |
|---|---|---|---|---|---|---|---|---|
| LF1 @ 5° C. | — | 0.08 | 0.16 | 0.19 | 0.22 | n/a | n/a | n/a |
| f1 @ 5° C. | Hz | 195 | 193 | 189 | 191 | n/a | n/a | n/a |

Table 3 with Comparative Example1: VG-SC+ acoustic tri-layer film
from Kuraray Europe GmbH, Ex 1-5 according to the invention

| | unit | Comp 1 | Ex1 | Ex2 | Ex3 |
|---|---|---|---|---|---|
| internal reference | | VG-SC+ R5 | K 8885 | K 8886 | K 8887 |
| safe break height | m | 5.25 | 4.75 | 4.5 | 1.75 |
| acc. ECE 43 for | | | | | |
| 2.26 kg ball | | | | | |
| water content by | % | 0.47 | 0.48 | 0.48 | 0.48 |
| NIR | | | | | |
| pummel adhesion | 0-10 scale | 3 | 4 | 4 | 4 |
| to air side | | | | | |
| pummel adhesion | 0-10 scale | 2 | 5 | 5 | 4 |
| to tin side | | | | | |
| compressive shear | N/mm2 | 11.8 | 11.6 | 6.8 | 6.7 |
| strength | | | | | |

1.-10. (canceled)

11. An interlayer film for laminated glazing, comprising at least one first and at least one second layer, each of said at least one first and second layers containing plasticized polyvinyl acetal, wherein said at least one first layer comprises polyvinyl acetal having a polyvinyl alcohol content from 10 to 16% by weight, a plasticizer content of at least 33% by weight and wherein the interlayer film has a total plasticiser content of at least 29% by weight and, when laminated between two glass panes of 2.1 mm thickness, exhibits after at least 4 weeks aging at 20° C. after lamination a second mode frequency f2 according to ISO PAS 16940 of less than 720 Hz.

12. The interlayer film of claim 11, wherein the interlayer film, when laminated between two glass panes of 2.1 mm thickness exhibits a decay of second mode resonance f2 according to the formula (f2w2−f2w4)/f2w2×100 of less than 5%.

13. The interlayer film of claim 11, wherein the second layer comprises a polyvinyl acetal having a polyvinyl alcohol content of 17 to 22% by weight.

14. The interlayer film of claim 12, wherein the second layer comprises a polyvinyl acetal having a polyvinyl alcohol content of 17 to 22% by weight.

15. The interlayer film of claim 11, wherein the second layer has a plasticiser content of at least 28% by weight.

16. The interlayer film of claim 13, wherein the second layer has a plasticiser content of at least 28% by weight.

17. The interlayer film of claim 11, wherein the polyvinyl alcohol content of the first and the second layer differ by at most 10% by weight.

18. The interlayer film of claim 11, wherein the first and/or the second layer comprises a mixture of a plasticiser and at least one non-ionic surfactant.

19. The interlayer film of claim 11, wherein the interlayer film has a total thickness of 0.9 to 1.15 mm

20. A laminate comprising at least two glass panes with at least one interlayer film of claim 11, wherein the at least two glass panes have different thicknesses.

21. A laminate comprising at least two glass panes with at least one interlayer film according to claim 11, wherein the glass panes have the same thickness.

22. An automobile and/or architectural window comprising a laminate of claim 20.

23. An automobile and/or architectural window comprising a laminate of claim 21.
